(19) United States
(12) Patent Application Publication
(10) Pub. No.: US 2016/0274687 A1
(43) Pub. Date: Sep. 22, 2016

(54) EXPLOSION-PROOF MEMBRANE ASSEMBLY, TOUCH SCREEN STRUCTURE AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD, Hefei (CN)

(72) Inventor: Hu LI, Beijing (CN)

(73) Assignees: BOE TECHNOLOGY GROUP CO., LTD., Beijing (CN); HEFEI XINSHENG OPTOELECTRONICS TECHNOLOGY CO., LTD, Hefei (CN)

(21) Appl. No.: 14/738,275

(22) Filed: Jun. 12, 2015

(30) Foreign Application Priority Data
Mar. 18, 2015 (CN) 201510119877.7

(51) Int. Cl. G06F 3/041; B32B 7/12; B32B 27/36; B32B 3/10

(52) U.S. Cl. CPC G06F 3/041; B32B 3/10; B32B 7/12; B32B 27/36; B32B 2307/412; B32B 2457/208

(57) ABSTRACT

The present disclosure provides an explosion-proof membrane assembly, a touch screen structure and a display device. The explosion-proof membrane assembly includes: an explosion-proof membrane substrate having two opposite surfaces; a sealant adhered onto at least one surface of the explosion-proof membrane substrate and located at a periphery of the explosion-proof membrane substrate; and a transparent filling layer arranged at an intermediate region surrounded by the sealant.

### CROSS-REFERENCE TO RELATED APPLICATION

The present application claims a priority of the Chinese patent application No. 201510119877.7 filed on Mar. 18, 2015, which is incorporated herein by reference in its entirety.

### TECHNICAL FIELD

The present disclosure relates to the field of touch screen, in particular to an explosion-proof membrane assembly, a touch screen structure and a display device.

### BACKGROUND

Along with the development of sciences and technologies, a common display screen for an electronic product has been gradually replaced with a touch screen, especially a capacitive touch screen. As one of the technologies for manufacturing the touch screen structure, One Glass solution (OGS) technology includes forming an indium tin oxide (ITO) conductive film and a sensor directly on a protective glass substrate, i.e., a glass sheet functions as the protective glass substrate and a touch sensor simultaneously. As compared with a traditional touch screen adopting a mainstream G/G touch technology, the touch screen adopting the OGS technology has such advantages as a simple structure, being thin and light, well light transmittance and low production cost, and thus has attached more and more attentions nowadays.

For the touch screen with an OGS structure, a touch panel (TP) is adhered to a liquid crystal display (LCD) module (LCM) by optical bonding or air bonding. For an optical bonding mode, an optically clear adhesive (OCA) or an optically clear resin (OCR) is used to completely adhere the TP onto the LCM. For an air bonding mode, as shown in FIG. 1, a sealant 30 is used to adhere the TP 10 onto the LCM 20 at their peripheries. The optical bonding mode is of high cost and difficult to be reworked, so currently the mark share of the product manufactured by air bonding is greater than that of the product manufactured by optical bonding.

However, there exist the following defects in the touch screen manufactured by air bonding. The sealant is a double-sided adhesive tape with a very small width, and has a frame-like shape. In order to improve its utilization, the sealant is usually cut into a bar-like shape or an L shape. As a result, the adhesion times of the sealant are increased, and meanwhile it is very difficult to ensure the adhesion accuracy. In addition, for the touch screen manufacturing by air bonding, the sealant is filled between the TP and LCM at their peripheries, so as to adhere them to each other. At this time, there is a gap between the TP and an intermediate display region of the LCM, i.e., the intermediate display region of the TP is in a suspending state. Usually, as shown in FIG. 1, an explosion-proof membrane 40 is provided inside the display region of the TP 10 (different from an external explosion-proof membrane provided outside the TP, this explosion-proof membrane may be referred to as an internal explosion-proof membrane), so as to reduce the gap between the TP and the LCM to some extent. However, generally the explosion-proof membrane is of a thickness obviously less than the sealant, so it is difficult to completely prevent the TP from being in the suspending state. When the display region of the TP is in the suspending state and the screen is pressed by a user to perform the touch operation, TP are deformed frequently, so a service life of the TP is shortened. In addition, a portion of the TP may be in direct contact with the LCM, which thereby results in such an adverse phenomenon as optical interference (e.g., Moire fringes and Newton's rings) and causes inconveniences to the user.

### SUMMARY

An object of the present disclosure is to provide in embodiments an explosion-proof membrane assembly, a touch screen structure and a display device, so as to combine a sealant and an explosion-proof membrane using the explosion-proof membrane assembly, thereby to reduce the adhesion times and the adhesion difficulty, improve the yield, and reduce Moire fringes on the touch screen manufactured by air bonding.

In one aspect, the present disclosure provides in embodiments an explosion-proof membrane assembly, including:

an explosion-proof membrane substrate having two opposite surfaces;

a sealant adhered onto at least one surface of the explosion-proof membrane substrate and located at a periphery of the explosion-proof membrane substrate; and a transparent filling layer arranged at an intermediate region surrounded by the sealant.

Further, the sealants are adhered onto the peripheries of the two opposite surfaces of the explosion-proof membrane substrate, respectively, and the transparent filling layer is arranged at the intermediate regions surrounded by each sealant.

Further, the transparent filling layer and the sealant located at an identical surface of the explosion-proof membrane substrate are of an identical thickness.

Further, the transparent filling layer includes:

a transparent support membrane; and

a fixation member configured to fix the support membrane at the intermediate region surrounded by the sealant.

Further, the fixation member includes an adhesion layer arranged between the support membrane and the explosion-proof membrane substrate.

Further, the adhesion layer is made of an optical adhesive.

Further, the adhesion layer is of a thickness of 5 μm to 50 μm.

Further, the adhesion layer is made of one of an OCA and an OCR.

Further, the fixation member includes an adhesive arranged around the support membrane and filled between the support membrane and the sealant.

Further, the support membrane is made of optical polyethylene terephthalate (PET).

Further, the support membrane is of a thickness of 25 μm to 200 μm.

In another aspect, the present disclosure provides in embodiments a touch screen structure, including:

a touch panel;

a display module arranged opposite to the touch panel; and

the above-mentioned explosion-proof membrane assembly arranged between the touch panel and the display module and configured to adhere the display module onto the touch panel.

In yet another aspect, the present disclosure provides in embodiments a display device including the above-mentioned touch screen structure.

According to embodiments of the present disclosure, the explosion-proof membrane assembly is used to combine the explosion-proof membrane substrate and the sealant together, and during the adhesion by air bonding, the explosion-proof membrane assembly may be directly adhered onto two substrates (e.g. the touch panel and the display module), so it is able to reduce adhesion times and the difficulty in adhesion, and to improve the yield. In addition, the transparent filling layer is arranged at the intermediate region surrounded by the sealant, so it is able to prevent the occurrence of a gap between the two substrates (e.g., the touch panel and the display module), thereby to reduce the optical interference, such as Moire fringes, of the touch screen manufactured by air bonding.

### BRIEF DESCRIPTION OF THE DRAWINGS

FIG. 1 is a schematic view showing a touch screen structure manufacturing by air bonding in the related art;

FIG. 2 is a schematic view showing an explosion-proof membrane assembly according to an embodiment of the present disclosure;

FIG. 3 is a schematic view showing the explosion-proof membrane assembly according to another embodiment of the present disclosure;

FIG. 4 is a schematic view showing a touch screen structure according to an embodiment of the present disclosure; and

FIG. 5 is a schematic view showing the touch screen structure according to another embodiment of the present disclosure.

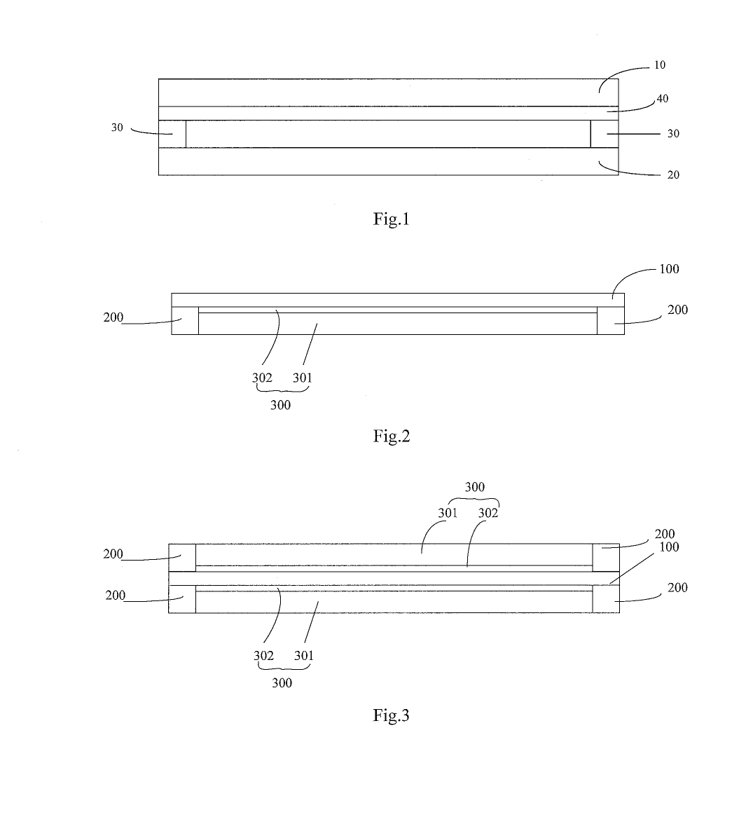

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments are merely a part of, rather than all of, embodiments of the present disclosure, and based on these embodiments, a person skilled in the art may obtain other embodiments, which also fall within the scope of the present disclosure.

In the related art, it is difficult to ensure the adhesion accuracy due to the adhesion times when adhering the touch screen by air bonding, and meanwhile, there exist such an adverse phenomenon as optical interference due to a gap between a touch panel and a display region of a display module. Hence, the present disclosure provides in embodiments an explosion-proof membrane assembly, so as to reduce the adhesion times and the adhesion difficulty, improve the yield, and reduce Moire fringes on the touch screen manufactured by air bonding to some extent.

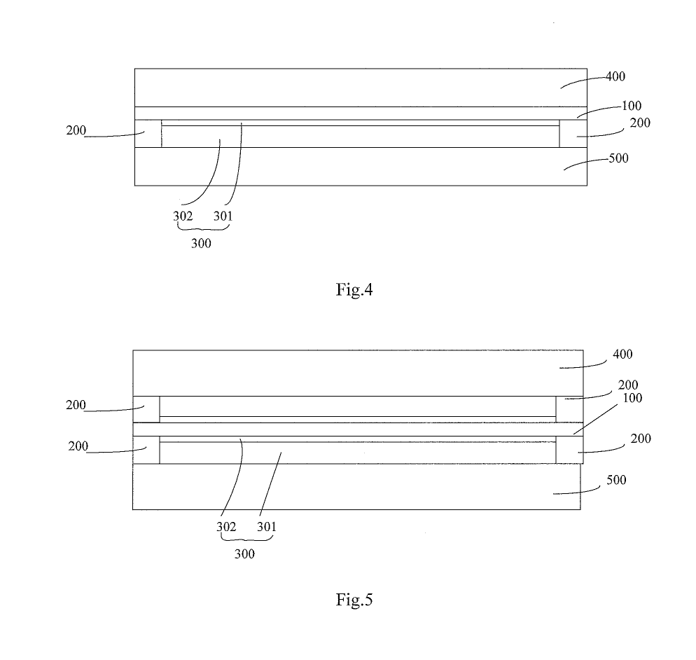

As shown in FIGS. 2 and 3, in an embodiment of the present disclosure, the explosion-proof membrane assembly for adhering two substrates includes:

an explosion-proof membrane substrate 100 having two opposite surfaces adhered to the two substrates, respectively;

a sealant 200 adhered onto at least one surface of the explosion-proof membrane substrate 100 and located at a periphery of the explosion-proof membrane substrate 100; and

a transparent filling layer 300 arranged at an intermediate region surrounded by the sealant 200.

According to embodiments of the present disclosure, the explosion-proof membrane assembly is used to combine the explosion-proof membrane substrate 100 and the sealant 200 together, i.e., the explosion-proof membrane substrate 100 and the sealant 200 are integrated as a product, and during the adhesion by air bonding, the explosion-proof membrane assembly may be directly adhered onto two substrates (e.g. a touch panel and a display module), so it is able to reduce the adhesion times and the difficulty in adhesion, and to improve the yield. In addition, the transparent filling layer 300 is arranged at the intermediate region surrounded by the sealant 200, so it is able to prevent the occurrence of a gap between the two substrates (e.g., the touch panel and the display module), thereby to reduce the optical interference, such as Moire fringes, of the touch screen manufactured by air bonding.

It should be appreciated that, the explosion-proof membrane assembly may be applied to a touch screen, especially an OGS touch screen, and also to any other product, manufactured by air boding.

The explosion-proof membrane assembly will be described hereinafter by taking a touch screen as an example.

As shown in FIG. 2, which is a schematic view showing the explosion-proof membrane assembly according to an embodiment of the present disclosure, the sealant 200 is adhered onto one surface of the explosion-proof membrane substrate 100, and the transparent filling layer 300 is arranged at the intermediate region surrounded by the sealant 200. As shown in FIG. 4, during the adhesion of a touch panel 400 and a display module 500, a surface of the explosion-proof membrane substrate 100 where no sealant 200 is provided may be, like a traditional internal explosion-proof membrane, directly adhered onto the touch panel, and then the touch panel 400 with the explosion-proof membrane assembly is adhered onto the display module 500 through the sealant 200. According to this embodiment, the explosion-proof membrane assembly may be of a small thickness, so as to provide a thin touch screen and save materials.

As shown in FIG. 3, which is a schematic view showing the explosion-proof membrane assembly according to another embodiment of the present disclosure, the sealants 200 are adhered onto the two opposite surfaces of the explosion-proof membrane substrate 100, respectively, and the transparent filling layer 300 is arranged at the intermediate region surrounded by each sealant 200. As shown in FIG. 5, during the adhesion of the touch panel 400 and the display module 500, the explosion-proof membrane substrate 100 may be directly adhered onto the touch panel 400 through the sealant 200 on one surface of the explosion-proof membrane substrate 100, and then the touch panel 400 with the explosion-proof membrane assembly may be adhered onto the display module 500 through the sealant 200 on the other surface of the explosion-proof membrane substrate 100. According to this embodiment, the two surfaces of the explosion-proof membrane assembly are adhered onto the touch panel and the display module through the sealants, respectively, and as a result, it is able to facilitate the adhesion and prevent the occurrence of bubbles.

In some other embodiments of the present disclosure, the sealants on the two opposite surfaces of the explosion-proof membrane substrate 100 may be of an identical thickness, or of different thicknesses.

In some other embodiments of the present disclosure, the sealant 200 may be adhered onto one surface of the explosion-proof membrane substrate 100, and any other adhesion structure for adhering the explosion-proof membrane substrate 100 onto a to-be-adhered substrate may be arranged on the other surface.

In embodiments of the present disclosure, alternatively, the transparent filling layer 300 and the sealant 200, which are arranged at an identical surface of the explosion-proof membrane substrate 100, may be of an identical thickness, as shown in FIGS. 2-5. For the touch screen manufactured by air bonding, there is a gap between the touch panel 400 and a display region of the display module 500 due to the sealant 200. When the transparent filling layer 300 and the sealant 200 arranged at an identical surface of the explosion-proof membrane substrate 100 are of an identical thickness, it is able to prevent the gap between the transparent filling layer 300 and the display module 500 or the touch panel 400, thereby to prevent the occurrence of such an adverse phenomenon as optical interference.

In embodiments of the present disclosure, alternatively, as shown in FIGS. 2 and 3, the transparent filling layer 300 includes a transparent support membrane 301, and a fixation member configured to fix the support membrane 301 at the intermediate region surrounded by the sealant 200. According to these embodiments, the transparent support member 301 is arranged at the intermediate region surrounded by the sealant 200 so as to form the transparent filling layer 300, thereby to further reduce the cost. In some other embodiments, the transparent filling layer 300 may also be made of some other transparent materials, e.g., an optical adhesive.

It should be appreciated that, the support membrane 301 should be transparent and have high light transmittance. Alternatively, the support membrane 301 may be made of optical PET. It should be appreciated that, in the actual application, the support membrane 301 may also be made of other materials, which are not particularly defined herein.

It should be further appreciated that, the structure of the support membrane 301 is not particularly defined in embodiments of the present disclosure, i.e., it may be of a single-layered or multi-layered structure. Alternatively, the support membrane 301 is of a single-layered structure having a thickness of 25 μm to 200 μm, and made of optical PET, or it is made of optical PET having a thickness of 50 μm.

In an alternative embodiment, the fixation member includes an adhesion layer 302 arranged between the support membrane 301 and the explosion-proof membrane substrate 100. According to this embodiment, the support membrane 301 is adhered onto the explosion-proof membrane substrate 100 through the adhesion layer 302, so as to fix the support membrane 301 onto the intermediate region surrounded by the sealant 200, thereby to provide a simple structure. Alternatively, a sum of the thickness of the support membrane 301 and a thickness of the adhesion layer 302 is equal to the thickness of the sealant 200, so that the transparent filling layer 300 is of a thickness identical to the sealant 200.

It should be appreciated that, the adhesion layer 302 should be transparent, have high light transmittance, and be easily adhered. For example, the adhesion layer 302 may be made of an optical adhesive. Alternatively, the adhesion layer 302 is made of an OCA or OCR. It should be further appreciated that, in the actual application, the adhesion layer 302 may also be made of other materials, which are not particularly defined herein.

It should be further appreciated that, alternatively, the adhesion layer 302 is of a thickness of 5 μm to 50 μm. Usually, a traditional sealant 200 is of a thickness of 80 μm. In an alternative embodiment of the present disclosure, the adhesion layer 302 is of a thickness of 30 μm and the support membrane 301 is of a thickness of 50 μm, so that the sum of the thickness of the support member 301 and the thickness of the adhesion layer 302 is equal to the thickness of the sealant 200.

In some other embodiments, the support membrane 301 may be fixed at the intermediate region surrounded by the sealant 200 in any other ways. For example, the fixation member includes an adhesive arranged around the support membrane 301 and filled between the support membrane 301 and the sealant 200, and the support membrane 301 may be adhered to an inner side of the sealant 200 through the adhesive. At this time, the thickness of the support membrane 301 may be identical to that of the sealant 200. Alternatively, the fixation member may include both the adhesion layer arranged between the explosion-proof membrane substrate and the support membrane, and the adhesive filled between the support membrane and the sealant. The structure of the fixation member will not be particularly defined herein.

It should be further appreciated that, in embodiments of the present disclosure, when the two opposite surfaces of the explosion-proof membrane substrate are provided with the sealant and the transparent filling layer, respectively, the sealant and the transparent filling layer on one surface may be of a structure identical to, or different from, those on the other surface.

It should be further appreciated that, the explosion-proof membrane substrate 100 should be transparent and have high light transmittance. Alternatively, the explosion-proof membrane substrate 100 may be made of optical PET having a thickness of 50 μm.

The present disclosure provides in embodiments a touch screen structure which, as shown in FIGS. 4 and 5, includes:

the touch panel 400;

the display module 500 arranged opposite to the touch panel 400; and

the above-mentioned explosion-proof membrane assembly arranged between the touch panel 400 and the display module 500 and configured to adhere the display module 500 onto the touch panel 400.

The present disclosure further provides in embodiments a display device including the above-mentioned touch screen structure.

Obviously, the touch screen structure and the display device in embodiments of the present disclosure also have the advantageous effects caused by the explosion-proof membrane assembly.

The above are merely the preferred embodiments of the present disclosure. It should be appreciated that, a person skilled in the art may make further modifications and improvements without departing from the principle of the present disclosure, and these modifications and improvements shall also fall within the scope of the present disclosure.

What is claimed is:

1. An explosion-proof membrane assembly, comprising:
an explosion-proof membrane substrate having two opposite surfaces;
a sealant adhered onto at least one surface of the explosion-proof membrane substrate and located at a periphery of the explosion-proof membrane substrate; and
a transparent filling layer arranged at an intermediate region surrounded by the sealant.

2. The explosion-proof membrane assembly according to claim 1, wherein the sealants are adhered onto the peripheries of the two opposite surfaces of the explosion-proof membrane substrate, respectively, and the transparent filling layer is arranged at the intermediate regions surrounded by each sealant.

3. The explosion-proof membrane assembly according to claim 1, wherein the transparent filling layer and the sealant located at an identical surface of the explosion-proof membrane substrate are of an identical thickness.

4. The explosion-proof membrane assembly according to claim 1, wherein the transparent filling layer comprises:
a transparent support membrane; and
a fixation member configured to fix the support membrane at the intermediate region surrounded by the sealant.

5. The explosion-proof membrane assembly according to claim 4, wherein the fixation member comprises an adhesion layer arranged between the support membrane and the explosion-proof membrane substrate.

6. The explosion-proof membrane assembly according to claim 5, wherein the adhesion layer is made of an optical adhesive.

7. The explosion-proof membrane assembly according to claim 6, wherein the adhesion layer is of a thickness of 5 μm to 50 μm.

8. The explosion-proof membrane assembly according to claim 6, wherein the adhesion layer is made of one of an optically clear adhesive (OCA) and an optically clear resin (OCR).

9. The explosion-proof membrane assembly according to claim 4, wherein the fixation member comprises an adhesive arranged around the support membrane and filled between the support membrane and the sealant.

10. The explosion-proof membrane assembly according to claim 4, wherein the support membrane is made of optical polyethylene terephthalate (PET).

11. The explosion-proof membrane assembly according to claim 4, wherein the support membrane is of a thickness of 25 μm to 200 μm.

12. A touch screen structure, comprising:
a touch panel;
a display module arranged opposite to the touch panel; and
the explosion-proof membrane assembly according to claim 1, arranged between the touch panel and the display module and configured to adhere the display module onto the touch panel.

13. The touch screen structure according to claim 12, wherein the sealants are adhered onto the peripheries of the two opposite surfaces of the explosion-proof membrane substrate, respectively, and the transparent filling layer is arranged at the intermediate regions surrounded by each sealant.

14. The touch screen structure according to claim 12, wherein the transparent filling layer and the sealant located at an identical surface of the explosion-proof membrane substrate are of an identical thickness.

15. The touch screen structure according to claim 12, wherein the transparent filling layer comprises:
a transparent support membrane; and
a fixation member configured to fix the support membrane at the intermediate region surrounded by the sealant.

16. The touch screen structure according to claim 15, wherein the fixation member comprises an adhesion layer arranged between the support membrane and the explosion-proof membrane substrate.

17. The touch screen structure according to claim 15, wherein the fixation member comprises an adhesive arranged around the support membrane and filled between the support membrane and the sealant.

18. The touch screen structure according to claim 15, wherein the support membrane is made of optical PET.

19. The touch screen structure according to claim 15, wherein the support membrane is of a thickness of 25 μm to 200 μm.

20. A display device comprising the touch screen structure according to claim 12.
